(19) United States
(12) Patent Application Publication
(10) Pub. No.: US 2017/0010520 A1
(43) Pub. Date: Jan. 12, 2017

(54) Protective Case for Electronic Camcorders for Air, Land and Underwater Use

(71) Applicant: Larry Tang, East Brunswick, NJ (US)

(72) Inventor: Larry Tang, East Brunswick, NJ (US)

(21) Appl. No.: 15/202,606

(22) Filed: Jul. 6, 2016

Related U.S. Application Data
(60) Provisional application No. 62/188,779, filed on Jul. 6, 2015.

(51) Int. Cl. G03B 17/08; H04N 5/225; A45C 11/38

(52) U.S. Cl. CPC G03B 17/08; A45C 11/38; H04N 5/2252

(57) ABSTRACT

A protective case for electronic camera/camcorders for air, land and underwater use having an audio port on an external surface of the case, communicating internally therewith, and a waterproof sealing device to controllably open or close the port to allow passage of sound to the electronic camera/camcorder within, as desired.

### CROSS-REFERENCE TO RELATED APPLICATIONS

A Provisional Patent Application covering the invention described herein was filed on Jul. 6, 2015, and assigned Ser. No. 62/188,779.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

Field of the Invention

This invention relates to electric camcorders, in general, and to those employing a protective case for air, land and underwater use, in particular.

Description of the Related Art

As has been described, if people wanted footage of themselves engaged in physical activities, until fairly recently, they needed another person to hold and operate an electronic camera for them. Furthermore, the camera operator needed to be skilled in order to obtain compelling content.

Additionally, capturing high-quality content often required expensive, fragile and cumbersome camera equipment that was not accessible to everyone. Accordingly, it was not often practical for people to document their experiences during their lives' most enjoyable moments.

In order to accommodate photography during such physical activities as skating, skiing, hiking, biking, mountain climbing and sky-diving, for example, camera manufacturers have recently come to develop, manufacture and market high-definition digital video electronic camera/camcorders, often used in these action video photographic instances. Compact, lightweight, rugged and simple to operate, camera/camcorders of this sort have been made available to capture still photos or video through a wide-angle lens, with accessories to mount to a helmet, to a bumper or to a windshield of a vehicle. Various wearable or mountable manners have also been developed to facilitate self-capture experiences different from those previously attainable with traditional cameras and smartphones.

Recognizing that the use of these camera/camcorders would also offer unique photographic perspectives in such activities as surfing, snorkeling, spear fishing, kayaking, white water rafting, and scuba-diving, protective cases claiming a. waterproof capability have been proposed to enclose these video systems for use in such environmental activities—or even just for wet-weather photographing in general.

### OBJECTS OF THE INVENTION

As these waterproof camera cases typically protect the electronic camera/camcorder when so used, they also operate to block any audio input to the built in microphone of the electronic camera/camcorder; if sound is desired, a different type of protective case is required. With this in mind, one object of the present invention is to provide a protective digital video camera case which offers an audio input capability to allow a user to employ the electronic camera/camcorder features whether involved in the air, on land and under water; i.e., in a water activity or otherwise.

### SUMMARY OF THE INVENTION

As will become clear from the following description, the protective case of the invention, for these electronic camera/camcorders for air, land and underwater use provides an audio port on a waterproof camera case along with a sealing device for underwater photo and video taking. In one embodiment of the sealing device, the audio port serves as an open cup to receive an insertable “sound blocking” closure plug for underwater and wet weather use. In a second embodiment, the audio port itself incorporates a waterproof acoustic membrane to let sound but not water through in the event the closure plug is forgotten to be inserted. The audio port, with either embodiment, will be understood to otherwise allow sound to reach the microphone of the electronic camera/camcorder unit. With both arrangements, furthermore, the plug is secured to the case so as not to come loose and separate. Moreover, the closure plug is designed not to generally dangle freely in those instances where it is removed for air and land usage of the digital video camera in the photographing or videographing operation.

### BRIEF DESCRIPTION OF THE DRAWINGS

These and other features of the invention will be more clearly understood from a consideration of the following description, taken in connection with the accompanying Drawings in which:

FIG. 1a is a front view of the plug of the sealing device of the invention (a rear view being a mirror image), FIG. 1b is a front perspective view, and FIGS. 1c and 1d are bottom and left side views respectively;

FIGS. 2a-2g are 7 views of a protective case for a digital video electronic camera/camcorder helpful in an understanding of the sealing device of the invention;

FIGS. 3a and 3b are top and perspective views, respectively, illustrating a portion of the digital video protective case helpful in an understanding of the connection of the sealing device open cup and the closure plug; and

FIGS. 4a- 4f are 6 views of a latch lock helpful in an understanding as to how the closure plug is firmly seated in the open cup of the sealing device when the back cover of the protective camera case is closed.

### DETAILED DESCRIPTION OF THE INVENTION

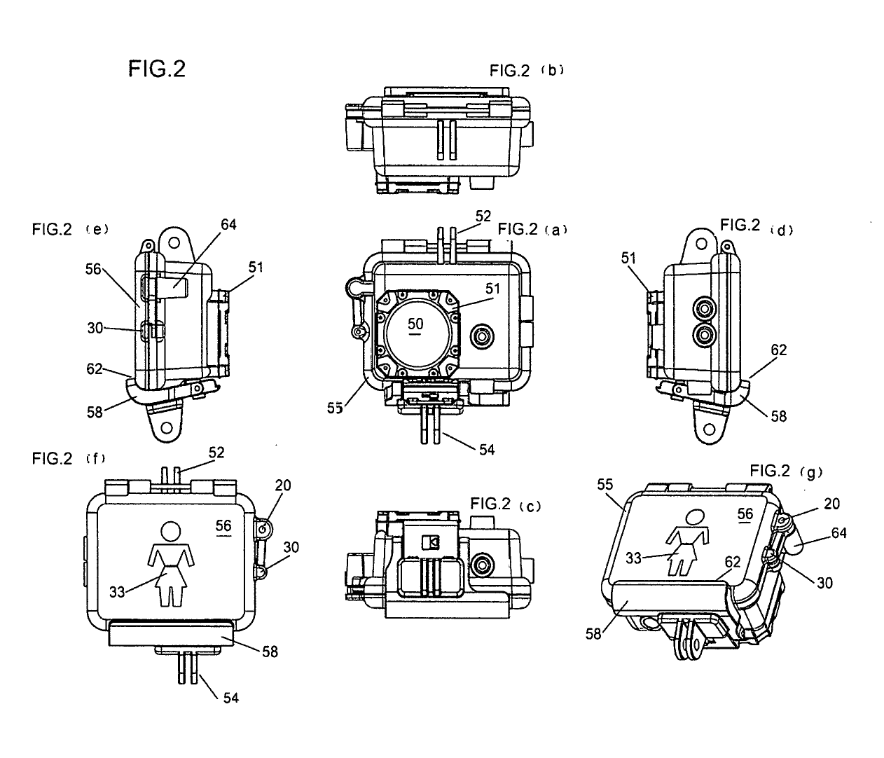

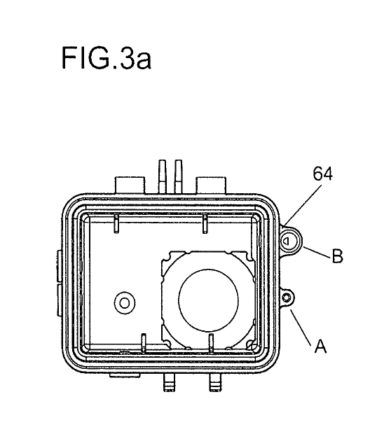

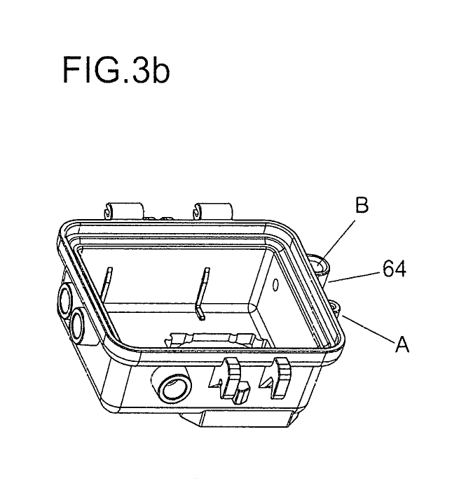

As will be appreciated, FIGS. 2a-2g respectively illustrate a front view of the protective waterproof case of the invention, a top plan view, a bottom plan view, a right side elevation view, a left side elevation view, a rear elevation view, and a rear perspective view. Reference numerals 50 and 51 identify a clear lens cover and a surrounding lens cover frame for the case 55, reference numerals 52 and 54 represent pillar receptors to couple to various mounts and accessories for the case and for the digital video electronic camera/camcorder enclosed within, and reference numeral 56 represents a transparent back cover. Reference numeral 58 represents a latch member to lock and hold the back cover 56 closed, with its lip 62 bendable outward to allow the back cover 56 to be opened and closed. Reference numeral 64 represents the cup of the audio port for passing sound into the compartment which encloses the electronic camera/camcorder. The cup 64 is additionally shown in FIGS. 3a and 3b as “open”, passing audio internally of the case 55 by way of an audio port aperture 65 (FIG. 3b).

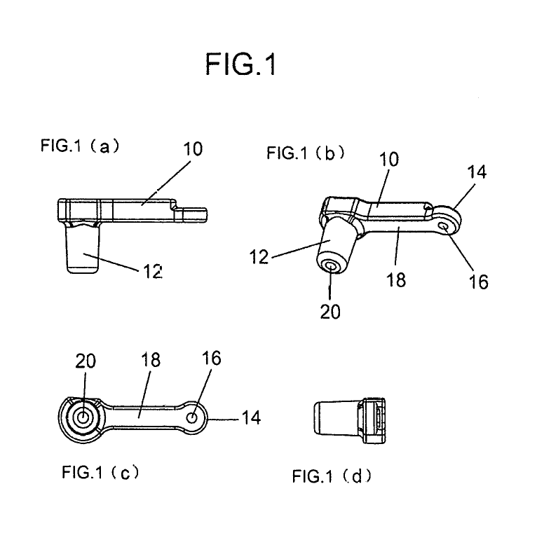

Referring to FIGS. 1a-1d, the sealing device of the invention 10 includes a component closure plug 12, an anchoring end 14 having an aperture 16, and a connecting stem 18. A screw or similar fastener 30 extends through the aperture 16 and back cover 56 (FIG. 2e) in securing the sealing device 10 to the protective case 55 (as at “A” in FIGS. 3a and 3b). The closure plug 12 (preferably of silicone) is sized and configured to seat and snugly fit into the open cup 64 of the audio port entry, shown at “B” in FIGS. 3a and 3b. Inserting the closure plug 12 (in accordance with this first embodiment of the sealing device of the invention) effectively seals off the audio port entry in a waterproof manner, without allowing the entry of sound to reach the electronic camera/camcorder's built-in internal microphone. This would be the situation when sound is not generally relevant—as in the underwater activities of snorkeling, spear fishing and scuba diving.

With this first version of the sealing device, therefore, waterproofing of the protective case is provided for underwater activity and sound does not enter the audio port entry when the closure plug is seated into the open cup. With the closure plug removed for air and land activity, sound enters the case to the internal microphone via the opened audio port entry.

Recognizing that a user might forget to insert the closure plug 12 for underwater activities, the second embodiment of the sealing device of the invention provides its own protection there—by including a thin waterproof acoustic membrane within, but spanning across the open cup of the audio port entry to vibrate in allowing the entry of sound wave pressures from an outside environment, but not water, into the electronic camera/camcorder protective case. Such embodiment will be understood also useful where the photographic activity is more in the nature of swimming, surfing, kayaking and white water rafting where waterproofing is desired along with some degree of sound accompaniment of the activity. As will be appreciated, however, this construction of the audio port entry is less desirable in sound reproduction for air and land usage than with the first embodiment of the sealing device where the closure plug 12 is simply withdrawn from the open cup 64 for best sound recording.

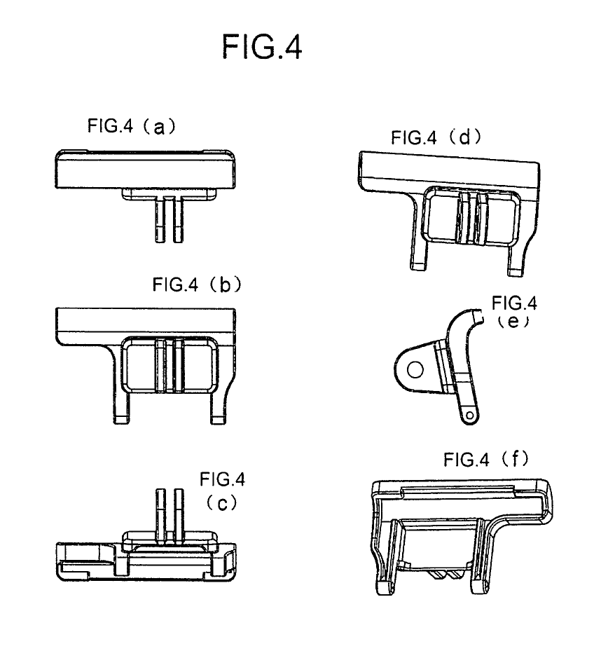

To further prevent the closure plug 12 dangling about when withdrawn from the open cup 64 for air and land use, the closure plug 12 is provided with a small magnetic tip 20 (FIGS. 1b and 1c) to join with a screw fastener in being held in place thereby. As illustrated in the protective case side views of FIGS. 2d and 2e and in the perspective view of FIG. 2g, and via the profile views of the latch member 58 in FIGS. 4a-4f, closing the latch member 58 to lock the back cover 56 is in a direction to urge the closure plug 12 into the open cup 64 in securing the closure plug 12 into position within the audio port entry—to not only enforce the waterproof seal that results, but to additionally act in a direction to prevent the closure plug 12 from accidently popping out. The screw fastening to the case in this respect is shown at 30 in FIGS. 2e, 2f and 2g. The logo 33 in FIGS. 2f and 2g merely represents a display on the screen of the enclosed digital video camera.

While what have been described are considered to be preferred embodiments of the present invention, it will be readily appreciated by those skilled in the art that modifications can be made without departing from the scope of the teachings herein. For at least such reason, therefore, resort should be had to the appended claims for a true understanding of the invention.

I claim:

1. In combination with a digital video electronic camera/camcorder enclosed within a waterproof protective case, apparatus comprising an audio port on an external surface of the case, communicating internally of the case, and a waterproof sealing device for said audio port.

2. The apparatus of claim 1 wherein said audio port includes an open cup and a waterproof sealing device, said waterproof sealing device having a first end secured with the case and a closure plug at a second end sized to removably seat within said open cup.

3. The apparatus of claim 1 wherein said audio port includes an open cup and a waterproof device, said waterproof sealing device including an acoustic waterproof membrane allowing sound wave pressure passage within and spanned across said open cup.

4. The apparatus of claim 3 wherein said acoustic waterproof membrane is of a thinness and composition to vibrate in accordance with sound wave pressure generated thereupon from an outside, external environment.

5. The apparatus of claim 2 wherein said closure plug is of a size to be snugly fit into and be withdrawable from said open cup in use.

6. The apparatus of claim 5 for use with a waterproof protective case having a latch member for locking a back cover thereof, wherein said closure plug is situate adjacent said latch member for urging into said open cup upon a closing of
